(19) United States
(12) Patent Application Publication
(10) Pub. No.: US 2007/0078877 A1
(43) Pub. Date: Apr. 5, 2007

(54) XBRL data conversion

(76) Inventors: Howard Ungar, Bethesda, MD (US); Gianluca Garbellotto, Alexandria, VA (US)

Correspondence Address: MORRISON & FOERSTER LLP, 1650 TYSONS BOULEVARD, SUITE 300, MCLEAN, VA, 22102, US

(21) Appl. No.: 11/407,360

(22) Filed: Apr. 20, 2006

Related U.S. Application Data
(60) Provisional application No. 60/672,860, filed on Apr. 20, 2005.
(60) Provisional application No. 60/698,020, filed on Jul. 12, 2005.

(51) Int. Cl. G06F 7/00

(52) U.S. Cl. 707/101

(57) ABSTRACT

A system, method and machine-readable medium are provided for converting data to, from, and between standard and proprietary formats using XBRL. The present invention provides a capability for extracting data from databases of a proprietary system and representing the extracted data using a standard format that can be interpreted and processed by any compliant application. The systems and methods of the present invention can provide a bridge application between information systems that use incompatible formats for storing data or that cannot otherwise exchange data

### REFERENCE TO RELATED APPLICATIONS

This application claims priority to U.S. Provisional Application Nos. 60/698,020 and 60/672,860, filed Jul. 12, 2005, and Apr. 20, 2005, respectively, the contents of which are hereby incorporated by reference.

### FIELD OF THE INVENTION

The present invention is directed to systems and methods for data processing including data aggregation, transformation between summary and detail levels, and conversion of data to, from, and between standard and proprietary data formats. More particularly, the present invention is directed to a suite of data processing tools using an eXtensible Markup Language (XML) taxonomy such as eXtensible Business Reporting Language (XBRL).

### BACKGROUND

XML is an information-content standard providing context to information. XML provides a grammatical structure to define and tag data, both textual and numerical, for use across various applications, such as spreadsheets and tax-preparation software. It provides a framework that facilitates the description of data and the sharing of it across applications, servers, and systems. XML provides a mechanism to attach uniform tags, or labels, to data that is then transmitted to others. The tags allow the data to be recognized by various applications across a multitude of systems.

One of XML's primary benefits is the ability to transmit, receive, and share information without data re-entry, enabling greater automation and less redundancy. Data coded, or tagged, with XML can be uploaded or downloaded into multiple applications by multiple users without manual intervention or translation. Financial data, for example, may be downloaded directly from a company website into a spreadsheet application for immediate analysis.

The most recognized specification of XML for the purposes of financial reporting is the extensible business reporting language (XBRL). XBRL is a variation of XML in which financial statement data is tagged based upon various GAAP standards, such as U.S. GAAP and International Financial Accounting Standards. XBRL is an international agreement on how to use XML and other related standards such as XLink to represent business and financial data at a detail level (XBRL GL) and financial reporting data at a summary level (XBRL FR). XBRL is a very effective technology for aggregating data coming from different sources in a central repository and for delivering information through the Internet. XBRL has been under development for several years and is being utilized by many organizations, including public companies and regulators.

In one exemplary application of XBRL, individuals and corporations may be able to file taxes by providing data to the Internal Revenue Service (IRS) in an XBRL format.

In another exemplary application of XBRL, factors can receive invoice information and legal documentation from their customers for each transaction in an XBRL format. XBRL is a logical vehicle for this and the factor would greatly benefit from the use of XBRL for its internal processes.

Despite the usefulness of XBRL, one impediment facing potential users is the fact that many of them have vast amounts of data stored in other proprietary or standardized formats. Additionally, even if a user would like to work with data in XBRL, the user may need to provide data in another format to another party or store data in another format. Therefore, there exists a need for systems and methods to facilitate the conversion of data to, from, and between XBRL formats.

Furthermore, the use of XBRL to represent business and financial data at a detail level through a widely agreed upon standard such as the XBRL GL taxonomy creates a need for a link between reported summary information and its source detail data which may be represented with XBRL FR or any XML schema. Such a link can be very useful for reconciliation and auditing purposes.

### SUMMARY OF THE INVENTION

This invention includes systems, methods, and computer-readable media for conversion of data to, from, and between standard and proprietary formats.

In one embodiment, the method for converting data from a first data structure to a second data structure includes receiving a first data set, the data defined according to the first data structure, receiving a definition of the second data structure, receiving an identification of a data type from the first data set, receiving an identification of a correspondence between the identified data type from the first data set and a data type defined in the second data structure, storing the correspondence in a binding file, and converting the first data set to a second data set defined according to the second data structure based on the correspondence in the binding file.

In another embodiment, the system for converting data from a first data structure to a second data structure includes a processor for receiving a first data set, the data defined according to the first data structure, receiving a definition of the second data structure, receiving an identification of a data type from the first data set, receiving an identification of a correspondence between the identified data type from the first data set and a data type defined in the second data structure, storing the correspondence in a binding file, and converting the first data set to a second data set defined according to the second data structure based on the correspondence in the binding file.

In a still further embodiment, the machine readable medium has instructions stored therein which when executed cause a machine to perform operations including receiving a first data set, the data defined according to the first data structure, receiving a definition of the second data structure, receiving an identification of a data type from the first data set, receiving an identification of a correspondence between the identified data type from the first data set and a data type defined in the second data structure, storing the correspondence in a binding file, and converting the first data set to a second data set defined according to the second data structure based on the correspondence in the binding file.

### BRIEF DESCRIPTION OF THE DRAWINGS

FIG. 1 illustrates an exemplary modular processing engine.

FIG. 2 illustrates an exemplary binder.

FIG. 3 illustrates an exemplary graphical user interface of the binder for specifying a binding and an attribute.

FIG. 4 illustrates an exemplary graphical user interface of the binder for specifying a binding and an additional element.

FIG. 5 illustrates an exemplary binding constructor.

FIG. 6 illustrates an exemplary loader.

FIG. 7 illustrates an exemplary mapping processor.

FIG. 8 illustrates several exemplary data flows.

### DETAILED DESCRIPTION OF THE INVENTION

The systems and methods of the present invention can include several different modules and processes for converting data to, from, and between standard and proprietary formats.

Some embodiments can extract data from a proprietary system and represent it using a standard format that can be interpreted and processed by any compliant application. Some embodiments can function as a bridge application to be used between information systems that use incompatible formats for storing data or that cannot otherwise exchange data.

An exemplary system for converting to and from XBRL formats can include some or all of the following components: a GUI interface for binding and mapping data from different sources such as comma-separated value (CSV) files or SQL databases to concepts defined in the target XBRL General Ledger (GL) and/or XBRL Financial Reporting (FR) taxonomies, an XBRL processor built on third party APIs for generating XBRL GL and XBRL FR instance documents, a report engine module for post-processing XBRL instance documents and related taxonomies into multiple human readable formats such as HTML, PDF or Word documents, and machine processable formats such as SQL queries, an XBRL processor including APIs for XBRL processing, and an XBRL loader for reading XBRL instance documents and loading the associated data into a database or a CSV file.

Some embodiments can be configured to consolidate data from different sources and reuse XBRL tagged information for multiple reporting and non-reporting purposes.

An exemplary method for converting to and from XBRL formats can include accepting data from a source information system through different formats (for example, CSV file, SQL query, or manual input) and normalizing the data using a given XML standard compliant convention that describes the structure and the ambiguities of the data. Normalization converts data expressed in different proprietary formats in a standard format so that it can be interpreted and used without the rigidity of the original format. An example of a standard convention that can be used for this purpose is the XBRL GL taxonomy, a standard for representing accounting facts which provides elements and rules to describe accounting, business and financial data in terms of the basic attributes that define the structure of each item of such data, for example the basic attributes of account codes, accounting entries, receivables and payables.

Some embodiments can include a capability for extracting data from a proprietary system and representing it using a standard format that can be interpreted and processed by any compliant application and a bridge application between information systems that use incompatible formats for storing data or that cannot otherwise exchange data.

In this description, it is assumed that an XBRL taxonomy is used to normalize the data. One skilled in the art will recognize that XBRL is only one possibility and that other taxonomies and data structures could be used. Additionally, at times, reference is made to a specific taxonomy such as XBRL GL or XBRL FR. One skilled in the art will recognize that, in many instances, an XBRL GL taxonomy or instance document could also be used where an XBRL FR taxonomy or instance document is referenced, and vice versa.

Process Overview

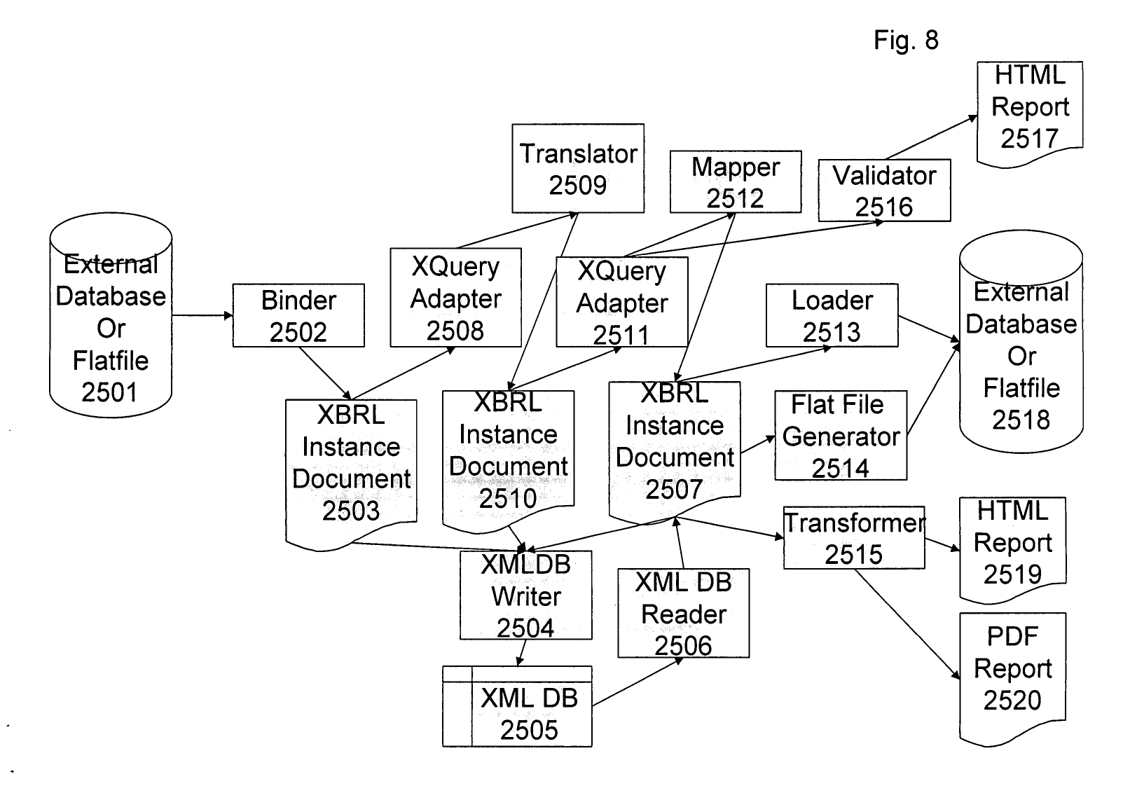

FIG. 8 illustrates an exemplary method by which data can be input in a format other than XML or XBRL, converted to an XML or XBRL format, and output to a format other than XML or XBRL. As illustrated in FIG. 8, data from an external database or flat file 2501 can be received as input at binder 2502. Binder 2502 can create an XBRL instance document 2503 which can be stored by XMLDB writer 2504 in an XML database 2505. Data from the XML database 2505 can be retrieved by an XML database reader 2506. The XML database reader 2506 can generate an XBRL instance document 2507. XBRL instance document 2503 can also be input to an XQuery adapter 2508. Output from the XQuery adapter 2508 can be input to translator 2509. Translator 2509 can then generate another XBRL instance document 2510 which can also be input to XMLDB writer 2504 or XQuery Adapter 2511. Output from XQuery adapter 2511 can be input to mapper 2512 or validator 2516. XBRL instance document 2507 can be input to loader 2513, flat file generator 2514, or transformer 2515. One of ordinary skill in the art will recognize that many other variations are possible, that any of the illustrated components could be connected in different ways, and that illustration is only one exemplary embodiment.

Various output options are possible. Data can be output in an HTML report 2517 with data from validator 2516, to an external database 2518 from loader 2513 or to a flat file 2518 from flat file generator 2514. Data can also be output to an HTML report 2519 or PDF report 2520 from transformer 2515. Some embodiments can include a flat file generator 2514 that can include a functionality such as line generator, line format, generate if changed, repeat counter, date formats, substitutions, expressions, and additional elements.

Output can be generated from normalized data in any human readable format, including but not limited to, HTML, PDF, and Microsoft Word formats. Data normalized using the given standard convention can be stored in a repository for further use by any application compliant with the given standard convention.

One of ordinary skill in the art will appreciate that XML and XBRL data generated by the systems and methods described herein can be stored in an XML Database with a shredding feature to optimize queries. Furthermore, XQuery and XSLT can be executed to query the XML database and documents and/or data retrieved.

Engine

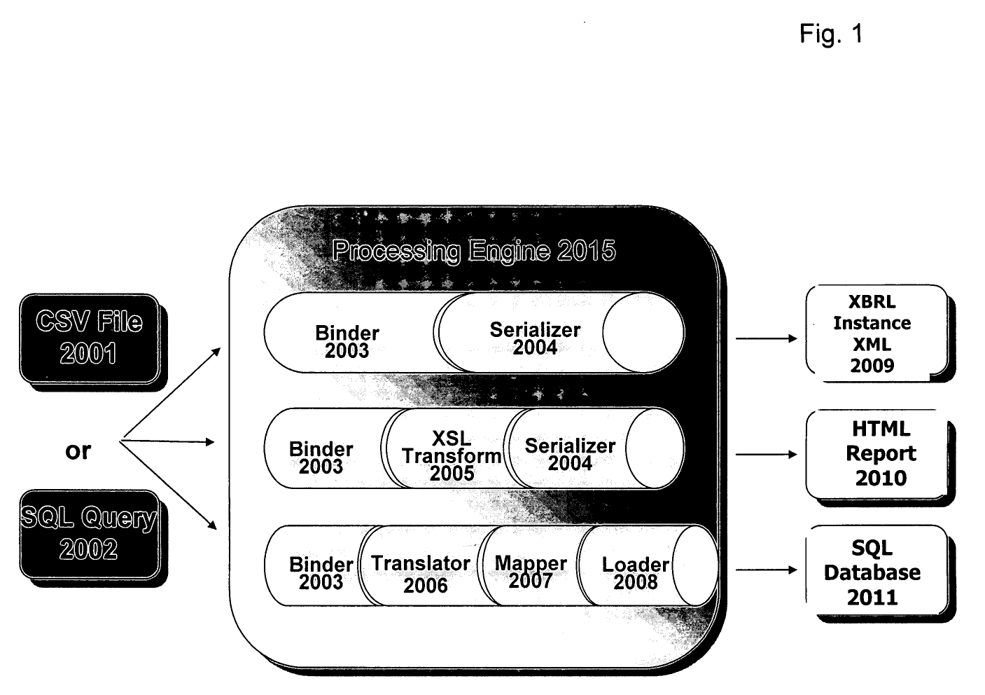

FIG. 1 illustrates an exemplary processing engine 2015. The engine provides a flexible execution environment for assembling components. Data can be transformed though the engine 2015. The engine 2015 can have as inputs data in any format, including a comma-separated value (CSV) file 2001. The engine can also have as input a query such as an SQL query 2002. The engine can be modular and can include components such as a binder 2003 in communication with a serializer 2004, a binder 2003 in communication with an XSL transform 2005 in communication with a serializer 2004, or a binder 2003 in communication with a translator 2006 in communication with a mapper 2007 in communication with a loader 2008. Other variations including components not illustrated are possible. Modules can be plugged into the engine and arranged in any order. Output from the engine can be in the form of an XBRL instance document 2009, an HTML report 2010, or an instruction to a SQL database 2011. Other output formats are possible.

Binder

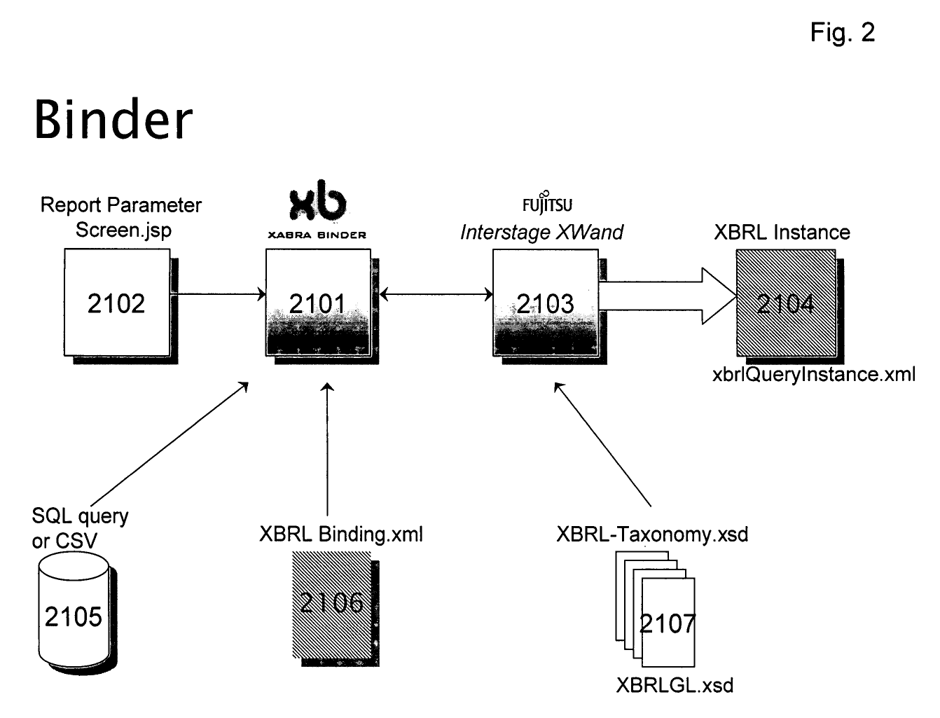

FIG. 2 illustrates an exemplary binder 2101. The binder 2101 takes as an input data from a report parameter screen 2102. The binder 2101 can also take as an input a SQL query or CSV file 2105 and an XBRL binding data file 2106. The binder 2101 can be in communication with Fujitsu Interstage XWand 2103 or another application development and runtime environment for building and deploying XBRL applications. XWand can receive an XBRL taxonomy 2107 such as XBRL GL. XWand 2103 processes the data and the output from XWand 2103 is an XBRL instance document 2104 such as an XBRL Query Instance.

One or more XBRL instance documents can be created based on the relationships stored in the binding file 2106. This binding file document can be divided in different sections, each section identified by a tag. As an example, the binding file can include constants, source data, and contexts. Constant values used in the process can be set or received as a parameter from a graphical user interface (GUI). Source data can contain instructions for the binding from source data elements to the XBRL concepts defined in the target XBRL taxonomy. Source data can contain different elements such as queries, data bindings, and group breaks.

If the source data is an SQL query, then the binding file contains a query section. In some embodiments, the query section could also be used to call a stored procedure. In some embodiments, the query section can be expanded to include SQL statements which can be used to populate temporary database tables.

Data bindings are the actual instructions on the binding from source data to the XBRL concepts of the target taxonomy. The data binding can contain zero or more additional element children. These additional elements can be used to emit an element with a particular value and context whenever the value in the binding is emitted.

Group breaks identify the fields or columns of the source data that the system can consider in order to create a new record when their values change. The group breaks can contain zero or more repeated tuple children. These repeated tuples are used to repeat certain elements in the source data whenever the group break changes value.

Contexts can specify the contexts and units to be used for the various concepts in the instance document.

The filename for one or more data binding files can be specified as a parameter in a report request, as described in more detail below.

The binder can include functionality including, but not limited to, group breaks, additional elements, suppressors, repeated tuples, substitutions, expressions, formats, constants, and parameters.

A repeated tuple can be used to instruct the binder to repeat a particular XBRL element when the group break causes a new break element to be emitted.

The suppressor attribute instructs the binder that a particular binding should be suppressed if another element has not yet changed. For example, if the gl-cor:entryHeader has not changed, but the source data contains two rows containing the same value which has a binding to an element which occurs inside of the entryHeader, then the suppressor can be used to keep the binding from repeating the same element again. As a non-limiting example, this feature can be used when working with the XBRL-GL taxonomy because typically there are multiple entryDetail elements contained within each entryHeader. For example, the batchID element might be repeated in every row of the source data but should only be included once in the entryHeader.

Binding Constructor

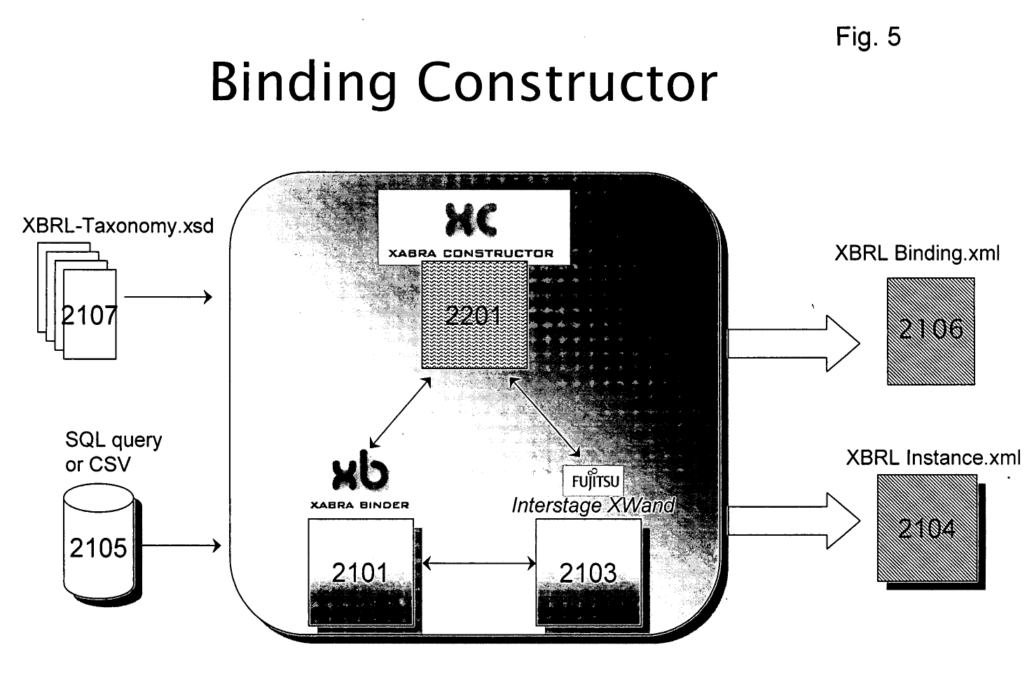

FIG. 5 illustrates use of a binding constructor 2201. An XBRL binding file 2106 for use with the binder 2101 can be generated by use of a graphical user interface in the binding constructor 2201. As shown in FIG. 5, the binder 2101 can have as inputs an XBRL taxonomy 2107 and an SQL query or CSV file 2105 and can be in communication with Fujitsu Interstage XWand 2103. Output can be an XBRL binding file 2106 and an XBRL instance document 2104.

The constructor can be designed to bind database columns or CSV files to taxonomy elements. This binding permits the association of attributes and additional elements to the bindings, creation of group breaks and repeated tuples, preview or saving of XBRL data binding files, and real-time creation of XBRL instance documents.

The constructor can be implemented as a graphical user interface. The interface can include any number of functions including, but not limited to, an initial user screen for a constructor module. The constructor can include a connection tab providing access to functionality for allowing the user to select an XBRL taxonomy file and enter values to connect to an SQL database or select a CSV file. The connection tab can also allow the user to load a pre-existing XBRL data binding file or template. The constructor can also use the connection tab to present a load screen for loading an existing XBRL binding file (XDBF).

Once a taxonomy and valid database connection are provided, the user can select an SQL tab whereby the user can define an SQL query, an SQL database, and can preview or execute queries. An “Execute” button can be provided for causing execution of SQL statements and thereby retrieving column specifications and data for previewing.

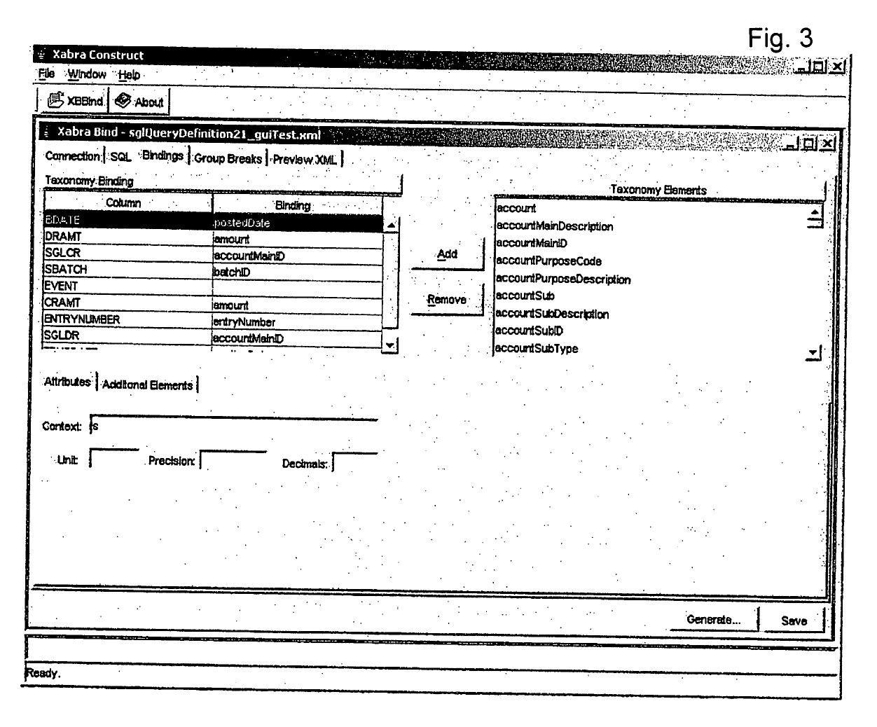

The constructor can also include a bindings tab for binding SQL columns to taxonomy elements to create a binding relationship. One or more attributes can be associated with the bindings. For example, a “context” attribute could be associated with a binding. In some embodiments, the bindings tab provides a list of database columns and a list of taxonomy elements. A binding can be created by selecting a column entry from the list of column entries, selecting a taxonomy element from the list of taxonomy elements, and then issuing a command to add the taxonomy element to the binding for the selected column entry. An exemplary interface for performing these actions is shown in FIG. 3.

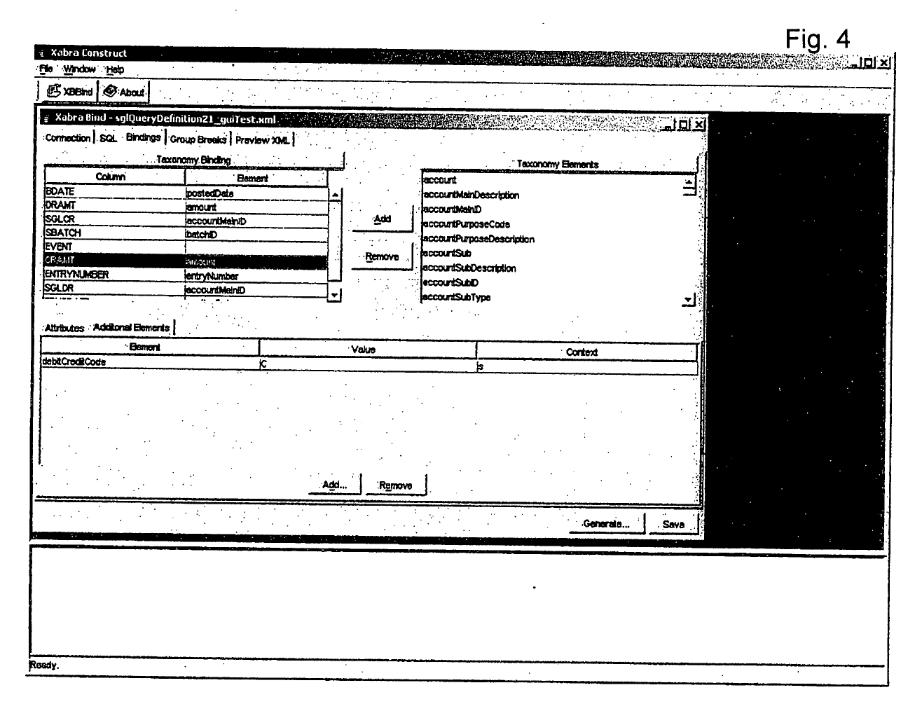

Additional elements can also be linked to individual bindings. An interface for designating additional elements is shown in FIG. 4. For example, a debit/credit code could be associated with an accounting code.

The constructor can include a group breaks tab. Using this functionality, a user can create individual group breaks through the association of a break element and a break generator. The break generator can be one of the taxonomy elements that has been bound. The break element is the taxonomy element of which a new instance is needed when the value of the break generator changes. In some embodiments, one or more repeated tuples can be assigned to individual group breaks.

A preview tab can be provided so that a user can preview the data created from the XBRL data binding file.

A generate button can also be provided. Activation of the generate button can cause retrieval of data from the database via the entered SQL query or from the selected CSV file. The generate button also links the data results to the bindings via the definitions and creates a resultant XBRL instance document.

A graphical interface can be provided for saving the XBRL data binding file as an XML document.

Loader

The conversion of data can also include accepting data from XBRL instance documents and loading the associated data into a database or CSV file. A tool can be provided that can be configured by a user to load data already in XBRL form into any database including Oracle, Microsoft SQL Server, Sybase, and others. The process of configuring the loader can include the use of a graphical user interface or constructor to define bindings from any XBRL taxonomy to a database. The resulting XBRL loader definition files can be used at runtime by the XBRL engine to provide web page or web service interfaces. These interfaces can consume XBRL instance documents and load them directly into any target database. The loader can generate SQL statements to effect the loading. Through this interface, bindings from any XBRL taxonomy to any SQL database can be defined.

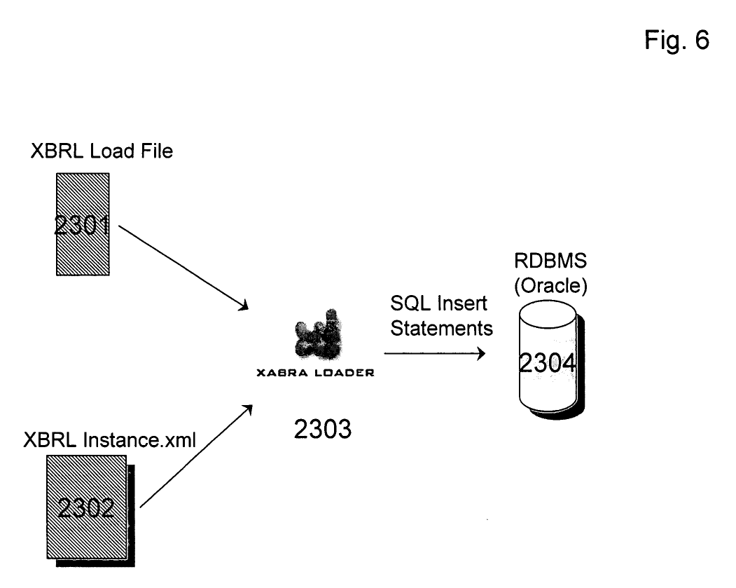

FIG. 6 illustrates the use of a loader 2303. The loader 2303 can read an XBRL instance document 2302 and generate, for example, SQL insert statements for use with RDBMS 2304. The loader 2303 also takes as input XBRL load file 2301.

The process of configuring the loader can be streamlined through the use of a GUI substantially similar to the constructor described above in connection with the binder. The interface can be in the form of a web page for loading an XBRL or XML instance document into an SQL database and specifying the summary output format as either summary or details. The user can be prompted to select a source XML or XBRL file. After loading, a summary output results of loading an instance document to a SQL database can be provided to the user identifying table names and record counts.

The loader can be provided as a tool for reading XBRL instance documents and loading the associated data into an SQL database. The loader can be configured by the XBRL load file to load data into any SQL-compliant database including Oracle, Microsoft SQL Server, Sybase, and others. The process of configuring the loader can use a constructor. Through the constructor, a user defines bindings from any XBRL taxonomy to any SQL database. The resulting loader definition files can be used by a report engine to provide web page or web service interfaces. These interfaces can consume XBRL instance documents whose bindings have been defined to load their associated data directly into a target database.

The XBRL loader definition file can include sections or tags for target data, data bindings, additional elements, and row generators. In the target data section, the sqlGenerator attribute specifies the database SQL generator such as an Oracle SQL generator. In the data bindings section, binding tags represent the link between a database table/column and the source taxonomy element. In the additional elements section, an AdditionalElement child elements of the binding tag are used to qualify that the binding only applies when there is an element present in the proximity of the binding sourceElement with the specified value. In the row generators section, the TableRowGenerator tags specify an ordered list of target tables to process. The generatorElement attribute specifies an element in the instance document that causes a new row to be created.

In one embodiment, the loader can be a flat file generator for generating output such as a CSV file. The flat file definition file can contain line generator and format elements. The format element specifies how a line should be generated in the flat file. It can contain an ordered list of columns which will be included in each line of the format. The formats are contained within a LineGenerator which specifies how the source data will be processed. The LineGenerator can contain a generatorElement attribute which identifies which element in the source data should be used to process the Formats. Formats can contain an optional “generateIfchanged” attribute in order to force that a new line only be generated if a particular element in the source document changes values. Formats can contain an optional repeatCount attribute which forces a new line to be generated if the lineGenerator generatorElement has been processed the number of times specified in the repeatCount.

The loader can include functionality known to one skilled in the art including, but not limited to, a row generator, repeated tuples, date formats, substitutions, expressions, and additional elements.

Mapping Processor

Some embodiments of the invention can include a mapping processor for converting data from one XBRL taxonomy to another XBRL taxonomy, translating from one set of accounting standards to another (e.g. from MSA to SGL), and/or summarizing from detail data to summary data. For example, detail data stored in XBRL GL instance documents can be converted to summary data stored in XBRL FR instance documents. One of ordinary skill in the art will recognize that any combination of taxonomies is possible.

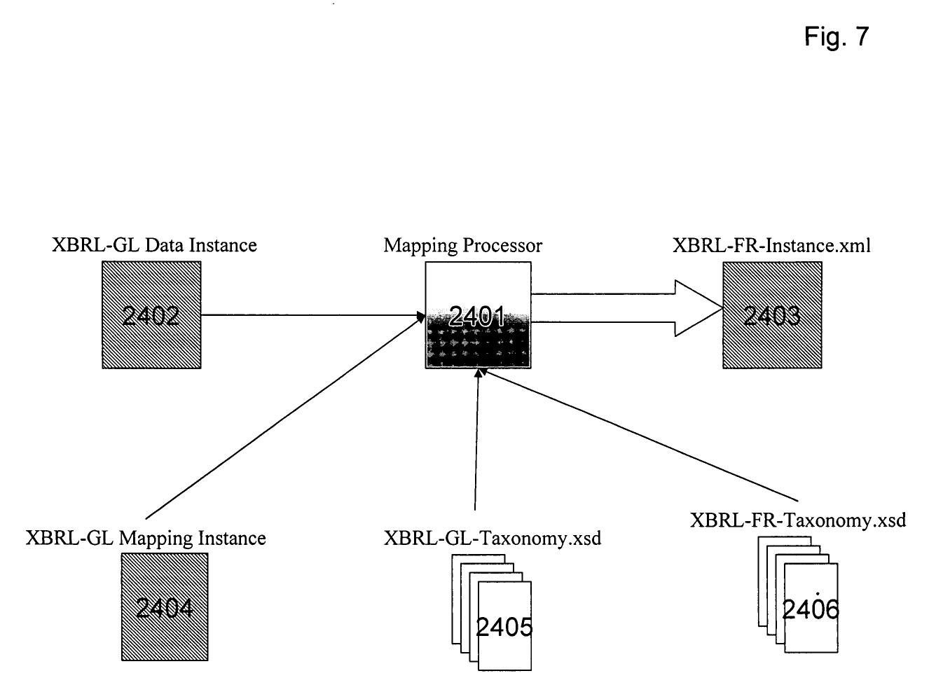

FIG. 7 illustrates an XBRL mapping processor 2401. The mapping processor 2401, like any of the components described herein, can be implemented in Java in some embodiments. As a non-limiting example, the processor 2401 can receive as input an XBRL GL instance document 2402, an XBRL GL mapping instance document 2404, an XBRL GL taxonomy document 2405, and an XBRL FR taxonomy document 2406. The mapping processor 2401 can then generate an XBRL FR instance document 2403.

The mapper can load the mapping file into memory. For the first xbrlInfo tag, the xbrlTaxonomy is read. If the taxonomy has not been loaded, it is loaded into memory. For each xbrlInfo tag, the following steps can be performed: each of the elements within the same entryDetail as the current xbrlInfo tag is used to generate an xpath expression, the xbrlInfo detailMatchingElement tag is read from the mapping and an xquery expression is generated to obtain the specified element's value, the xpath and xquery expressions are combined to create a single xquery, the resulting XQuery is executed against the source XBRL GL instance document, the result of the XQuery is a single value which is used to create a new item in the target XBRL FR taxonomy, and the xbrlInfo xbrlElement tag is read from the mapping and used to create the new item in the target XBRL FR taxonomy.

In some embodiments instance documents can be generated into multiple taxonomies at the same time if the xbrlInfo elements contain different taxonomies. In some embodiments, different contexts, units, precisions, and decimal places could be used in the target instance document. In some further embodiments, the same contexts, units, precisions, and decimal places could be used as the ones in the source XBRL GL instance document.

In some embodiments the mapper can determine what level to consider when looking at the pattern in the mapping instance document. This determination can be based on the entryDetail or entryHeader. The entryDetail could be used if there are xbrlInfo tags for each entryDetail. The entryHeader could be used if there is only one entryDetail per entryHeader. In still further embodiments, it is possible to always consider everything in the hierarchy if the mapping includes elements that are pertinent.

Alternatively, or in addition, a pivot tag can be used to instruct the mapper what element to consider when processing a pattern.

As discussed above, mapping can be used to generate Financial Reporting (FR) instance documents from XBRL GL instance documents. In some embodiments, to perform the mapping, one or more XBRL GL instance documents exists in an XML repository or file system, a mapping file exists which specifies how XBRL GL entries should be mapped into the target Financial Reporting taxonomy, and the specified XBRL Financial Reporting taxonomy exists on an XML repository or file system.

Mapping can also include a new element for the definition file to express mapping functions which support copying scalar values, and aggregate functions such as sum(), count(), and avg(). When the mapping is converting from detail to summary instance documents, the mapper can also include group-by functionality that can generate an XML query which groups values in the source instance based on one or more definition files which contain XBRL GL elements which represent a specified pattern. Mapping pivot functionality can include a new element for the definition file which specifies how to process the instance document and can specify the element used as the starting point for searching the source instance document for groups of common values in the group-by function. When the mapping is translating between accounting systems such as from MSA to SGL, a new element for the definition file can specify one or more constant values which should be inserted into the target instance document.

As a result of the mapping, one or more XBRL instance documents are generated and stored in an XML repository or file system, the mapping used to create the instance documents may be stored in the XML repository for use in a drill-down use case, the system generates and stores a list of the detail XBRL GL instance documents used to generate the summary XBRL instances for use in the drill-down use case.

In some embodiments, a glXBRLInfoMappingInstance file can be created as an instance document of the GL taxonomy which includes XBRLInfo elements. For example, these elements can map an account number defined in a AccountMainID element to the downstream taxonomy element defined in the xbrlTaxonomy and xbrlElement elements. This XBRLInfo mapping file can be used by the XBRLInstanceGenerator to generate instances of the taxonomies defined in the xbrlTaxonomy element.

The binder, loader, flat file generator and mapper can include inputs for substitutions, expressions, constants and parameters.

A substitution can be used to allow the user to specify that a particular value in the source data should be replaced with another value in the output. For example, if the value “D” is encountered in the source data, the output will contain the word “debit”

Expressions can be used allow the user to specify an expression which can be used in the place of a binding. This allows for features such as concatenation, math functions such as, but not limited to, addition, multiplication, modulo, and access to counters.

Constants can be used to specify a value which will not change. However, the value of a constant can be specified at runtime through the use of parameters. For example, in the binder, a constant value can be bound to a particular XBRL element. This allows values which do not exist in the source data to be specified and included in the output.

Parameters can be specified in the various definition files by addition a special symbol such as an “@” to the front of a named field. These parameter fields are replaced with the parameter values when the request is processed.

Reporting Engine

Some embodiments can include a reporting engine. The reporting engine can generate an output in any format capable of being processed by, for example, a) a software application in order to transfer the normalized data into a target information system or, b) a software application that is not XML compliant, or c) a software application that is XML compliant but is not capable of using XML for the specific purpose pursued. An example of this kind of output is an SQL query that is used to insert the normalized data into a target SQL database. Where the final output includes summarizations of the normalized data, a specific module can retrieve the links between each element of the structure of the information (for example, the XBRL GL taxonomy) and each element of the format in which the information is represented (for example, the XBRL FR taxonomy) and provide the user a visual or graphical tool to drill down from the summarized value to its detail and vice versa.

When the input comprises one or more XBRL instance documents, a corresponding set of loader definition files can be generated using a definition generator or a constructor for input to an XBRL loader that loads the instance documents into any SQL compliant database using the loader definition files.

In the event of a drill down, a summary XBRL instance document has been stored in the XML repository, the user has identified an element within the summary XBRL instance document for which detail is desired, the list of detail XBRL instance documents used to generate the summary XBRL instance document has been stored in the XML repository, and the mapping file used to generate this summary XBRL instance document has been stored in the XML repository. As a result, the reporting system returns an XML result containing the Detail elements which correspond to the selected summary XBRL element. This result can be processed with an XSL stylesheet to produce PDF or HTML output.

Two choices for sub-elements of EntryDetail can be included. One choice may be to include only those elements specified in the mapping file. Another choice may be to include all elements in the EntryDetail. If the EntryDetail contains multiple amount fields and all elements in the EntryDetail are requested, the detailMatchingElement from original mapping can be used when identifying the appropriate amount field to display. Alternatively, or in addition, the reporting engine can be configured to keep a list of valid detailMatchingElement elements and trim other amount elements excluding the one that is in the mapping. This could be performed in a post-process.

Mapping Drilldown Design

The drilldown report can utilize the mapping file to reverse the mapping process by performing the following steps:
a. Read the mapping file into memory.
b. Search for the selected summary XBRL element in the xbrlElement and xbrlTaxonomy elements of the xbrlInfo tag in the mapping file.
c. Generate an XQuery into the detail XBRL instance document to retrieve entries that match the detail corresponding to the selected xbrlInfo element.
d. Return an XML document containing these detail elements.

Report Configurations

The reporting engine can be configured to allow report developers to easily plug-in the logic for transforming the parameters into complex queries. Different queries may be involved in generating data for different parts of the report. For example, the master, detail and summary sections may come from different queries. Each of these queries can generate separate result set XML that can be made available to the various stages of the XSLT processing.

Reports can be defined as a set of sequential processing steps or stages. Various process engines can be called for each stage of the report processing. The report and each of its stages can be configurable through an external (XML) file to allow additional transformation stages to be added at a later time without requiring any change to the java code. The configuration file can reside in the application server file system rather than deployed along with the rest of the application to allow report configurations to be changed without re-deploying the application to the EJB container. Any java components can reside in an EJB Jar file.

XML Report Configurations are used to piece together various components for processing a report request. XBRL instance document creation can be based on one or more report configurations predefined in the ReportConfiguration.xml file. These configurations specify the sequence of stages used to process the report request. XBRL instance creation configurations can use the XBRLInstanceProcess stage. The xbrlAPIClass attribute defines which XBRLapi class will be instantiated. Additional stages which might be used include a ReportTransformer stage for processing XSL Stylesheets, a ReportSerializer for generating XML documents from jaxp DOM objects, and a ReportFOProcessor for generating PDF documents from XSL-FO documents.

The XBRLInstanceProcess generates an XBRL instance document. The ReportTransformer uses an XSL stylesheet to convert the XBRL to XSL formatting objects. The ReportFOProcessor converts the XSL formatting objects to a PDF file.

In order to allow background processing for longer running report processing, the report engine can be configured to provide an asynchronous interface in front of the synchronous reporting engine. This asynchronous interface can be implemented with either the Java Messaging System (JMS) or Simple Object Access Protocol (SOAP). To support asynchronous report execution and regularly scheduled shared reports, the reporting system can be configured to store the results in an intermediate data store for future retrieval. This data store could be implemented with Oracle, Unix file systems, or an XML Database Server such as eXcelon's eXtensible Information Server (XIS) or Oracle's XML DB. Stored report results can be used as inputs to subsequent report requests.

Users of the report system can have the ability to define regularly scheduled reports. Through a graphical interface, users can manage these scheduled reports and retrieve results from them.

Report Requests

The client can assemble a report request to specify the report configuration and parameters to the report. The Report request can be passed to the ReportEngine in the processRequest method. The ReportOutput object can be returned when the report is completed. Since XBRL processing may create multiple instance documents, the ReportOutput can be modified to contain multiple output documents.

The report request contains report configuration and report parameter components. The report request specifies which report configuration will be used to process the request. By selecting different report configurations the user can obtain alternative output types including XML, HTML, and PDF. Various report parameters can be specified depending on the specific requirements of the report. Some or all of these can be optional in some embodiments. The xbrlInstanceGeneratorDefinitionFile parameter specifies which XBRL Instance Generator Definition File will be used for the request. The glXBRLInfoMappingInstance parameter specifies which glXBRLInfo Mapping instance document will be used to generate instances of downstream taxonomies. The XSLStyleSheet parameter can be used to specify which XSL stylesheet file should be used to post process the XBRL into either HTML or PDF output. The csvFileName parameter specifies which CSV file to open if the xbrlDefinitionFile SourceData type attribute is set to “CSV.” The Query Substitution parameters are used if the xbrlDefinitionFile SourceData type attribute is set to “Query.” Additional parameters can be provided which will be used to substitute for any part of the xbrlDefinitionFile which contains a “@” variable.

The user can be presented with a set of report parameters. These parameters can provide choice lists, input ranges and wildcards. The user can be given different output formatting options such as text, HTML, PDF, CSV and Word. When the user submits the report request the user can be shown a confirmation screen indicating that the report is being processed. Once the report is ready the user can be shown the report results. The report parameters can be validated and any errors are shown to the user. If the report execution fails the user can be shown an error screen indicating the problem (e.g., server is unavailable).

In addition to the standard parameters, the user can have the option to schedule the report for future execution. The parameter screen can include the ability to run background, delayed or periodic reports. The background choice can run the report immediately but the user may go the Access Results use case to access the results. The delayed report choice allows the user to pick a future date and time to execute the report. The scheduled report can allow the user to pick from a range of schedule periods (e.g., daily, weekly, monthly, quarterly, yearly). When the report is submitted, the user can be shown a list of scheduled reports. This list can also be accessed from the main menu and can allow the user to delete or modify a scheduled report.

If the report parameters or scheduling parameters have any errors, the user is shown an error indicating the problem area. If the report fails, an error message is stored in the results area.

The user can access previously executed reports and report schedules that are stored on the server. Results may be the result of a scheduled or regular report run. The user can be presented with a list of report results and global report results. This list can indicate the requested run date and time and the status. The user can take several actions against these results including: view, download, remove, and re-run. The re-run option can take the user to the parameter screen for that report with the parameters populated according to the selected result. The view option can take the user to a screen containing the report results. The download option can allow the user to selected a directory for saving the result.

If the report contains errors, or is currently executing, the view option may be disabled. If the report is currently running, a cancel option can be included and the remove option can be disabled.

Report Definitions

A generic report definition can be described using an XML report definition file. The report definition can include a row generator for defining how the source instance will be processed to generate a row of data, detail columns for specifying how columns will be laid out on the page (heading label, wrapping, and alignment), bindings for specifying which element in the source instance document contains relevant data, constants for allowing the source of a column to be a constant value, anchors for drill-down for specifying how to query the source detail instance. In one embodiment, the drill down processing can be based on the selected summary element, and processing by looking at the XBRL summarizer definition file to determine which elements and values to use for the query. In another embodiment of the anchor, the XBRLInfo tags in the source instance document can be queried based upon the selected element in the summary. The report definition can also support standard report layout features based on the XML data source such as report bands including heading, summary, detail, column layout, top title, bottom title and features such as line, new page, reference, nested report, page number, report date, line text, text label, and layout format.

An XSL stylesheet can be used to post-process the XBRL into human readable formats. These formats include, as non-limiting examples, PDF and HTML. The stylesheet can provide a template for transforming the XBRL instance document into the selected format. The stylesheet can be specified at runtime as part of the report request and many different stylesheets can be used without changing the report configuration file.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A method for converting data from a first data structure to a second data structure, comprising:
receiving a first data set, the data defined according to the first data structure;
receiving a definition of the second data structure;
receiving an identification of a data type from the first data set;
receiving an identification of a correspondence between the identified data type from the first data set and a data type defined in the second data structure;
storing the correspondence in a binding file; and
converting the first data set to a second data set defined according to the second data structure based on the correspondence in the binding file.

2. The method of claim 1, further comprising receiving the identification of the data type from the first data set through a user interface.

3. The method of claim 1, further comprising receiving the identification of the correspondence between the identified data type from the first data set and the data type defined in the second data structure through a user interface.

4. The method of claim 1, wherein the second data structure is defined in a taxonomy.

5. The method of claim 4, wherein the taxonomy is an eXtensible Markup Language (XML) taxonomy.

6. The method of claim 1, wherein the first data structure is an eXtensible Business Reporting Language General Ledger (XBRL GL) taxonomy.

7. The method of claim 6, wherein the second data structure is an eXtensible Business Reporting Language General Ledger (XBRL FR) taxonomy.

8. The method of claim 1, wherein the first data structure is an eXtensible Business Reporting Language Financial Reporting (XBRL FR) taxonomy.

9. The method of claim 8, wherein the second data structure is an eXtensible Business Reporting Language General Ledger (XBRL GL) taxonomy.

10. The method of claim 1, wherein the second data structure is an eXtensible Business Reporting Language General Ledger (XBRL GL) taxonomy.

11. The method of claim 1, wherein the second data structure is an eXtensible Business Reporting Language Financial Reporting (XBRL FR) taxonomy.

12. The method of claim 1, further comprising providing the first data set as an instance document.

13. The method of claim 1, further comprising providing the second data set as an instance document.

14. The method of claim 1, further comprising storing the first data set as a comma-separated value (CSV) file, structured query language (SQL) file, or flat file.

15. The method of claim 1, further comprising storing the second data set as a comma-separated value (CSV) file, structured query language (SQL) file, or flat file.

16. The method of claim 1, further comprising providing a graphical user interface for navigating links between the first data structure and the second data structure, wherein the first data structure is an eXtensible Business Reporting Language Financial Reporting (XBRL FR) taxonomy and the second data structure is an eXtensible Business Reporting Language General Ledger (XBRL GL) taxonomy.

17. The method of claim 1, further comprising providing a graphical user interface for navigating links between the first data structure and the second data structure, wherein the first data structure is an eXtensible Business Reporting Language General Ledger (XBRL GL) taxonomy and the second data structure is an eXtensible Business Reporting Language Financial Reporting (XBRL FR) taxonomy.

18. The method of claim 1, further comprising providing a graphical user interface for navigating links between the first data structure and the second data structure, wherein the first data structure is an eXtensible Business Reporting Language General Ledger (XBRL GL) taxonomy containing summary data and the second data structure is an eXtensible Business Reporting Language General Ledger (XBRL GL) taxonomy containing detail data.

19. A method for converting data from a source taxonomy to a target taxonomy, comprising:
receiving a source instance document and a source taxonomy document;
receiving a target taxonomy document;
receiving a mapping instruction file identifying at least one correspondence between a data type in the source taxonomy document and a data type in the target taxonomy document; and
converting the source instance document to a target instance document based on the mapping instruction file.

20. A system for converting data from a first data structure to a second data structure, the system comprising a processor for:
receiving a first data set, the data defined according to the first data structure;
receiving a definition of the second data structure;
receiving an identification of a data type from the first data set;
receiving an identification of a correspondence between the identified data type from the first data set and a data type defined in the second data structure;
storing the correspondence in a binding file; and
converting the first data set to a second data set defined according to the second data structure based on the correspondence in the binding file.

21. The system of claim 20, wherein the second data structure is defined in a taxonomy.

22. The system of claim 21, wherein the taxonomy is an eXtensible Business Reporting Language (XBRL) taxonomy.

23. A machine-readable medium having instructions stored therein which when executed cause a machine to perform a set of operations comprising:
receiving a first data set, the data defined according to the first data structure;
receiving a definition of the second data structure;
receiving an identification of a data type from the first data set;
receiving an identification of a correspondence between the identified data type from the first data set and a data type defined in the second data structure;
storing the correspondence in a binding file; and
converting the first data set to a second data set defined according to the second data structure based on the correspondence in the binding file.

24. The machine-readable medium of claim 23, wherein the second data structure is an eXtensible Business Reporting Language (XBRL) taxonomy.
